(19) United States
(12) Patent Application Publication
(10) Pub. No.: US 2014/0218478 A1
(43) Pub. Date: Aug. 7, 2014

(54) METHOD AND APPARATUS FOR STEREOSCOPIC IMAGING

(71) Applicants: MASSACHUSETTS INSTITUTE OF TECHNOLOGY, (US); NATIONAL UNIVERSITY OF SINGAPORE, Kent Ridge (SG)

(72) Inventors: Matthew J. Lang, Nashville, TN (US); Taishi Zhang, SG (SG); Victor Horodincu, Singapore (SG); Siew Kit Hoi, Singapore (SG)

(73) Assignees: NATIONAL UNIVERSITY OF SINGAPORE, Kent Ridge (SG); MASSACHUSETTS INSTITUTE OF TECHNOLOGY, Cambridge, MA (US)

(21) Appl. No.: 13/762,139

(22) Filed: Feb. 7, 2013

(51) Int. Cl. G03B 35/02; G02B 27/26; G02B 27/22

(52) U.S. Cl. CPC G03B 35/02; G02B 27/2228; G02B 27/26
USPC 348/46; 359/464; 359/465

(57) ABSTRACT

A device is disclosed that utilizes color or polarization to generate two separate images of the same object taken from the two perspectives that correspond to the left and right eyes of an observer. The two separate images are captured through a single camera objective (e.g., a single shutter camera), resulting in a single image with 3D information encoded in the color or polarization. Advantageously, the images are captured simultaneously, permitting obtaining stereoscopic images of both static and moving subjects, allowing 3D video capture. The device can be an attachment to a conventional, single shutter, image capturing device, such as a camera, a smart phone with a camera feature, computer with a camera feature, and so on.

### BACKGROUND OF THE INVENTION

Due to the binocular nature of human vision, two eyes “see” from slightly different perspectives. Our brains produce a stereoscopic (“3D”) combination of these images with depth perception. Compared with a projection of a three-dimensional image onto a two-dimensional surface (“2D imaging”), 3D imaging encodes more object position information, particularly depth. Currently 3D imaging requires either two integrated and matched cameras for simultaneous 3D imaging, or repositioning of a single camera for sequential 3D image capture. One method is a dedicated 3D camera with dual lens and dual image sensors. Despite the possibly higher cost, the versatility of this method is low. Another current method for 3D imaging is to acquire two “sequential” images with the same camera, each image acquired at a slightly different perspective. The images are later combined into a 3D format through post-processing. Due to the minimal requirements on camera type and model, this method is particularly popular among smartphone users. However the intrinsic drawback of this method is that it only works with still subjects. Video is not possible, as the method does not work for moving subjects where the position changes drastically between the two independent shots. Problems of cost, design complexity, alignment and timing synchronization limit the utility of the present methods.

### SUMMARY OF THE INVENTION

One example of the present invention is an attachment to an image-capturing device, including single shutter devices such as a camera, a laptop computer or a mobile phone, that enables such an image-capturing device to take 3D images and videos.

Accordingly, an example embodiment of the present invention can comprise a left-eye channel; a right-eye channel; and a beam combiner. The left-eye channel is configured to relay a left-eye beam to the beam combiner; the right-eye channel is configured to relay the right-eye beam to the beam combiner; and the beam combiner is configured to combine the left-eye beam with the right-eye beam and to form a single combined beam.

In another example, the present invention is a system for acquiring a stereoscopic image. The system can comprise an attachment for acquiring a stereoscopic image as described above and an image acquisition device.

In another example, the present invention is a kit comprising an attachment for acquiring a stereoscopic image, as described above, and a device for viewing a stereoscopic image.

In another example, the present invention is a kit comprising an attachment for acquiring a stereoscopic image, as described above, and a computer-readable media with computer code instructions stored thereon, the computer code instructions causing an image display apparatus to display the stereoscopic image.

In another embodiment, the present invention is a system for acquiring a stereoscopic image. The system comprises a detector having a frame rate; a left-eye channel; a right-eye channel; a beam controller, the left-eye channel configured to relay a left-eye beam to the detector, the right-eye channel configured to relay a right-eye beam to the detector. The beam controller is configured to alternatively transmit either the left-eye beam or the right-eye beam to the detector at a switching rate that is equal to or less than the frame rate of the detector.

In another example, the present invention is a method for acquiring a stereoscopic image. The method comprises acquiring a left-eye image, carried by a left-eye beam; acquiring a right-eye image, carried by a right-eye beam; and combining the left-eye image and the right-eye image to form a single combined image.

In another example, the present invention is a method for acquiring a stereoscopic image. The method comprises acquiring a left-eye image carried by a left-eye beam; acquiring a right-eye image, carried by a right-eye beam; and alternatively transmitting either the left-eye beam or the right-eye beam to a detector at a switching rate, the detector having a frame rate, the switching rate being equal to or less than the frame rate of the detector.

In another example, the present invention is an apparatus for acquiring a stereoscopic image. The apparatus comprises means for acquiring a left-eye image, carried by a left-eye beam; means for acquiring a right-eye image, carried by a right-eye beam; and means for combining the left-eye image and the right-eye image into a single combined image.

In another example, the present invention is an apparatus for acquiring a stereoscopic image. The apparatus comprises means for acquiring a left-eye image carried by a left-eye beam; means for acquiring a right-eye image, carried by a right-eye beam; and means for alternatively transmitting either the left-eye beam or the right-eye beam to a detector at a switching rate, the detector having a frame rate, the switching rate being equal to or less than the frame rate of the detector.

### BRIEF DESCRIPTION OF THE DRAWINGS

The patent or application file contains at least one drawing executed in color. Copies of this patent or patent application publication with color drawings will be provided by the Office upon request and payment of the necessary fee.

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic diagram showing how a Bayer-filter equipped digital camera captures color images.

FIG. 2 is a schematic diagram of an example embodiment of the present invention.

FIG. 3A is a sample combined red/blue image taken by iPhone using an example attachment of the present invention.

FIGS. 3B and 3C are single color images that resulted in the anaglyph 3D image shown in FIG. 3A. The images in FIGS. 3B and 3C were taken from the left-eye and the right-eye perspective, respectively.

FIG. 4A is a schematic diagram of an example embodiment of an attachment of the present invention.

FIG. 4B is a photograph of an example embodiment of an attachment of the present invention shown in FIG. 4A.

FIG. 5 is a schematic diagram of an example embodiment of the present invention.

FIG. 6 is a schematic diagram of an example embodiment of the present invention.

FIG. 7 is a ray-tracing diagram illustrating the optical train of an example attachment of the present invention.

FIG. 8 is a sample image taken by a single shutter camera using the example attachment shown in FIGS. 6.

FIG. 9 is a schematic diagram of an embodiment of the present invention that relies on a polarization mosaic array.

FIGS. 10A, 10B, and 10C are collectively a schematic diagram illustrating the principle of operation of a polarization mosaic array.

FIG. 11 is a schematic diagram of an embodiment of the present invention that relies on a polarization mosaic array.

FIG. 12A is a schematic diagram of an embodiment of the present invention.

FIGS. 12B and 12C are schematic diagrams of two synchronization schemes that can be implemented in the device shown in FIG. 12A.

FIG. 13 is a schematic diagram of an embodiment of the present invention.

FIG. 14 is a schematic diagram of an embodiment of the present invention.

FIG. 15 is a schematic diagram of an embodiment of the present invention.

### DETAILED DESCRIPTION OF THE INVENTION

A description of example embodiments of the invention follows.

An example embodiment of the present invention is a device that utilizes color filters or polarization filters to generate two separate beams carrying two separate images of the same object taken from different perspectives. The two perspectives correspond to the human left and right eye perspectives. The two separate beams are directed into a single camera objective (a single shutter camera), resulting in a single image with 3D information encoded in the color or polarization. A significant advantage of such a design is that the same lens is used for each eye perspective, thus permitting to capture a stereoscopic image with a single-shutter image acquisition device. Another advantage is that the images are captured simultaneously and work for both static and moving subjects, allowing 3D video capture. The device can be an attachment to a conventional, i.e. single shutter image capturing device.

In the example embodiments in which the device of the present invention is an attachment, the device can further include a means for securing the attachment to an image acquisition device. Examples of such means include a clip, a screw and a bolt, a pin, or any other mechanical device suitable for securing two items together. One example of such means is a metallic platform that is affixed around the lens, such as a washer affixed to the image acquisition device by a magnet. Another example of such means is a “dovetail” attachment arrangement whereby the attachment can be slid in place. Another example of such means is a conventional threaded camera mount and a number of components that link this camera base to the attachment such that the attachment can be positioned in front of the objective lens of the camera.

In certain example embodiments, such means for securing permit rotation of the attachment relative to the image acquisition device. Such rotation can allow taking the stereoscopic images in either the “portrait” or a “landscape” configuration. It will be appreciated by a person of ordinary skill in the art that the methods described herein, in their reliance on a single objective (single shutter) image acquisition devices, advantageously permit acquiring either a portrait or a landscape images.

In further embodiments, the attachment described herein includes a mechanism that permits tilting the left and right eye angles so that they are parallel or crossed at an arbitrary or fixed position. This is important for the perspective in capturing the stereoscopic view.

In further embodiments, the attachment described herein includes a mechanism that permits moving the left-eye channel relative to the right-eye channel by an arbitrary distance. For example, the left-eye channel and right-eye channel can be separated by about 6 cm. In other examples, the channels can be moved apart beyond 6 cm, or moved closer than 6 cm to each other. Such movement can be accomplished by any mechanism known to a person of ordinary skill in the art, such as a threaded component. Another example embodiment of the present invention is a device that includes a single shutter image acquisition device. The device further includes means for generating two separate beams carrying two separate images of the same object taken from different perspectives. In one example embodiment, each of the two images is captured in a corresponding frame by the image acquisition device. In another example embodiment, both images are captured within a single frame of the image acquisition device. Described in detail below, means for generating two separate beams can include two additional shutters, movable mirrors that control which beam reaches the objective lens, two polarization filters in combination with a polarization control elements, such as a liquid crystal element or Pockels cells.

Additionally, such a single-shuter image acquisition device useful for practicing the present invention can include a photodetector (CCD or CMOS) that employs a polarization mosaic array described, for example, in U.S. Pat. No. 7,420,542, incorporated herein by reference in its entirety.

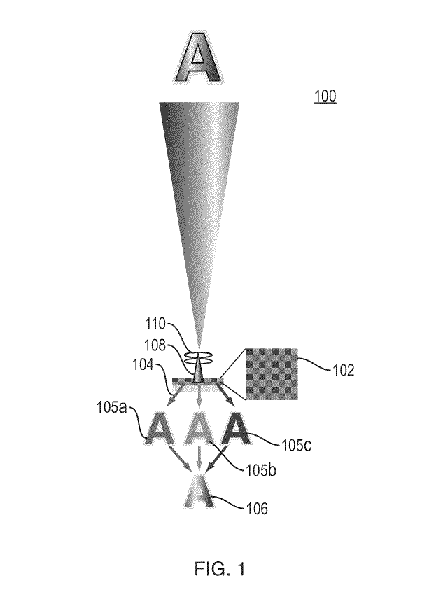

To understand the present invention in more detail, some basic knowledge on how digital cameras capture color images is beneficial. FIG. 1 is a schematic diagram of a conventional digital camera 100. Most digital cameras employ a Bayer filter, a standard color mask 102, usually stacked on a CCD/CMOS sensor 104. The sensor 104 of the digital camera 100 is a matrix of pixels, which can be considered as an array or matrix of wells for photons. After exposure, the number of photons falling into each well is counted and converted into a grayscale image. Without the color mask 102, the sensor 104 is actually a black-and-white device with no ability to distinguish colors by itself. To create a color image 106, a color filter array 102 is placed right before the sensor 104 to allow penetration of only a particular color. The most widely used color filter array is the Bayer filter, which passes red (R), blue (B) and green (G) alternately. After a beam 108, focused by the objective lens 110, passes through the Bayer filter 102, each pixel of the sensor 104 can only receive photons of one of these RBG primary colors. The true color image 106 is reconstructed from three single color images 105a, 105b, and 105c in a process called demosaicing. Demosaicing methods are well-known to a person of ordinary skill in the art.

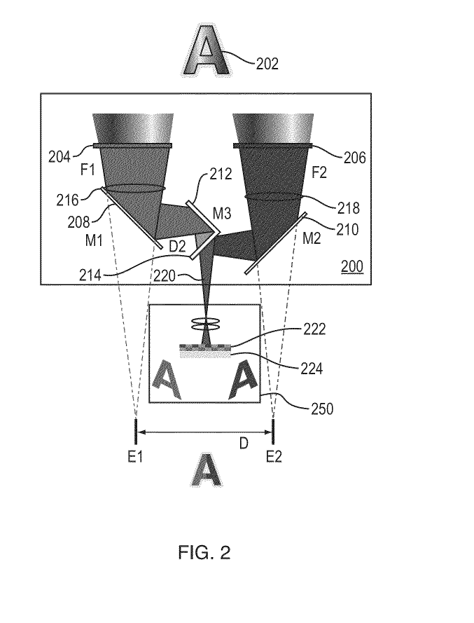

An example embodiment of the present invention is a device for acquiring a stereoscopic image that can be an attachment to a single-shutter image acquisition device. The attachment comprises a left-eye channel, a right-eye channel, and a beam combiner. The left-eye channel is configured to relay a left-eye beam to the beam combiner, the right-eye channel is configured to relay the right-eye beam to the beam combiner. The beam combiner configured to combine the left-eye beam with the right-eye beam and to form a single combined beam. Such an embodiment is a device 200 illustrated in FIG. 2.

Referring to FIG. 2, the device 200 includes a left-eye channel color filter F1 (204) and a left-eye channel mirror M1 (208), and a right-eye channel color filter F2 (206) and a right-eye channel mirror M2 (210). A beam combiner of the device 200 comprises a mirror M3 (212) and a dichroic filter D2 (214). In one embodiment of the device 200, color filters 204 and 206 are not included.

Referring to FIG. 2, beams carrying an image of a subject 202 are directed into color filters F1 (204) and F2 (206). Color filters 204 and 206 can be anaglyphically colored. A person of ordinary skill in the art of stereoscopic image acquisition will appreciate that numerous anaglyphic color schemes exist. The colors shown throughout the instant disclosure are chosen as “red” and “blue” for illustrative purposes only.

As used herein, the term “anaglyph” refers to the stereoscopic effect achieved by means of encoding each eye's image using filters of different (usually chromatically opposite) colors. Anaglyph images contain two differently filtered colored images, one for each eye. When viewed through the “color coded” “anaglyph glasses,” each of the two images reaches one eye, revealing an integrated stereoscopic image. The visual cortex of the brain fuses this into perception of a three dimensional scene or composition.

In the example shown in FIG. 2, two broadband mirrors M1 (208) and M2 (210) are mounted at approximately 45° with respect to the optical axis of the respective filters 204 and 208 to reflect light onto mirror M3 (212) and dichroic filter D2 (214), which can be a mirror. As shown in FIG. 2, dichroic filter D2 (214) can operate by transmitting red light and reflecting the shorter wavelength—blue-light. Other schemes are possible. Mirror M3 (212) and dichroic filter D2 (214) in combination operate as a beam combiner. As a result, the left-eye beam 216 and the right-eye beam 218 are combined into a single combined beam 220.

FIG. 2 depicts a single-shutter image acquisition device 250 as being separate from the device 200. It is understood that in certain embodiments, the image acquisition device 250 may be an integral part of the device 200.

The single combined beam 220 is then directed through a Bayer's mask 222 onto a detector 224. As a result, a standard color camera sensor can be used to obtain a 3D image. The image captured by a camera in the example embodiment of FIG. 2 includes a red- and blue-light images. These images are spatially separated on the detector 224. Each image contains information from a different perspective. The stereoscopic image can be viewed on a conventional display by wearing red-blue glasses. Alternatively, image-processing software can be used to reconstruct the 3D image and to display it on a 3D display that does not require the viewer to wear a device for viewing the stereoscopic image, such as goggles, a lenticular array, or a parallax array.

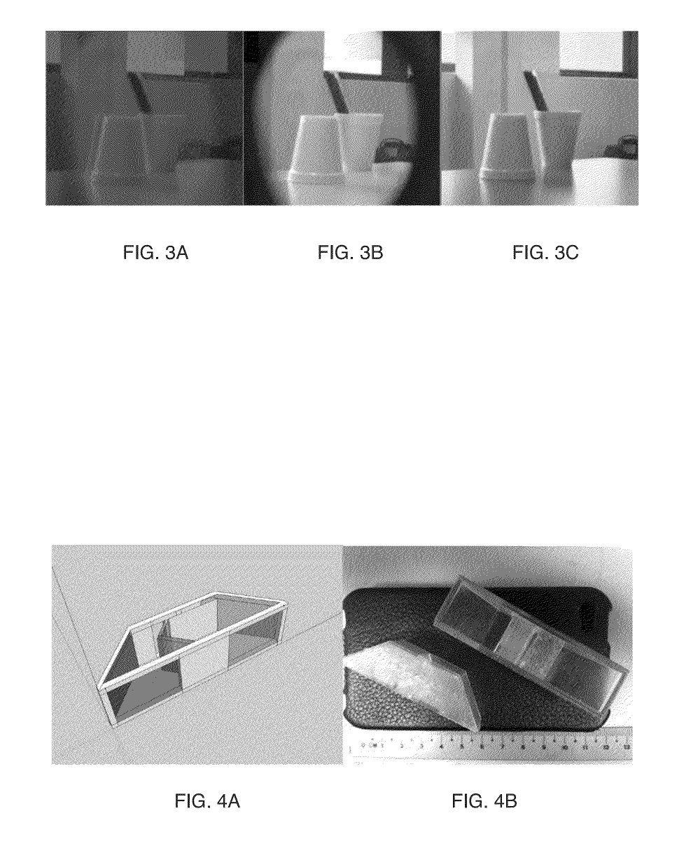

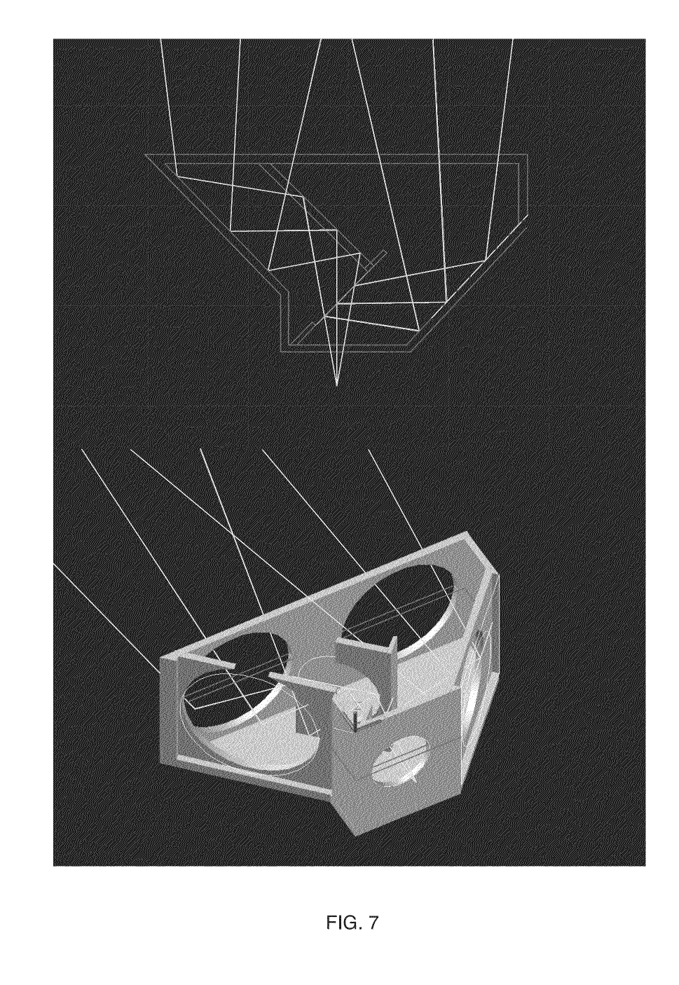

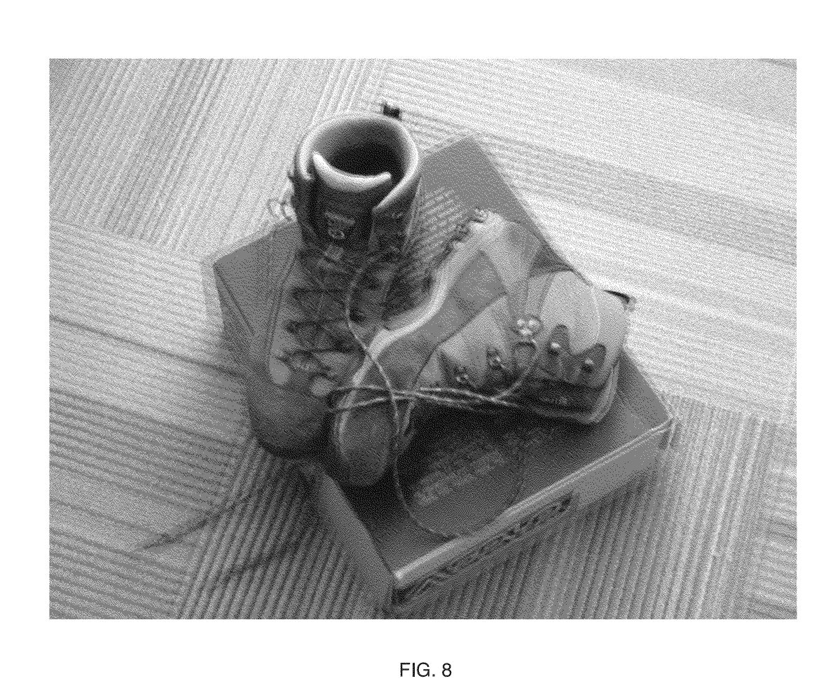

FIGS. 3A through 3C illustrate the use of a device exemplified in FIGS. 4A and 4B and operating according to the principle explained above with respect to FIG. 2. The combined red/blue image in FIG. 3A was taken by iPhone®. The two single images in FIGS. 3B and 3C show different perspectives. The 3D effect in FIG. 3A can be seen with blue-red glasses. FIG. 7 is a ray-tracing diagram illustrating the optical train of the device shown in FIGS. 2, 4A, and 4B. FIG. 8 is a sample image taken by a single shutter camera using the example attachment shown in FIGS. 2, 4A and 4B.

Device 100 shown in FIG. 2 and in FIGS. 4A and 4B can be used as an attachment to a smartphone or a digital single-shutter camera.

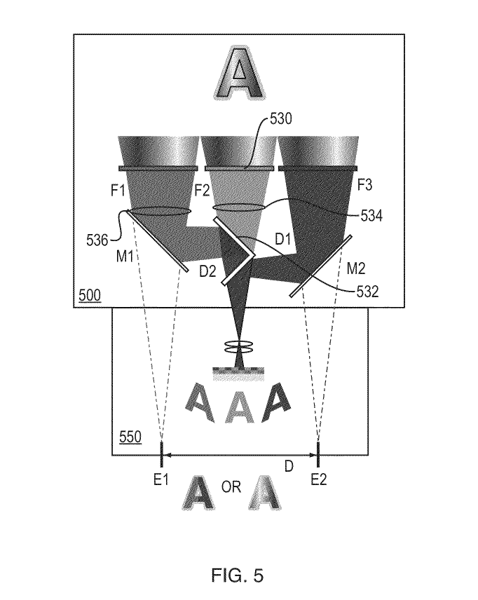

A further example embodiment of the present invention is device 500, shown in FIG. 5. The device 500 employs a color compensation scheme to convey the colors in the stereoscopic image more accurately. In the example embodiment shown in FIG. 5, in addition to the elements employed in device 200 of FIG. 2, the device 500 further includes a compensating color filter 530. The compensating color filter 530 can be selected to pass the light in the spectral regions disposed in between the colors passed by the left-eye channel and the right-eye channel, such as a green color where left is red and right is blue.

The mirror M3 (212) of the device 200 is replaced with a second dichroic filter D1 (532) that transmits the compensating beam 534 but reflects the colored beam 536.

FIG. 5 depicts a single-shutter image acquisition device 550 as being separate from the device 500. It is understood that in certain embodiments, the image acquisition device 550 may be an integral part of the device 500.

Image post-processing, using methods well-known to one of ordinary skill in the art, can be performed either by the image acquisition device 550 or by a special or general purpose computer to render a color-compensated 3D image acquired using the device 500.

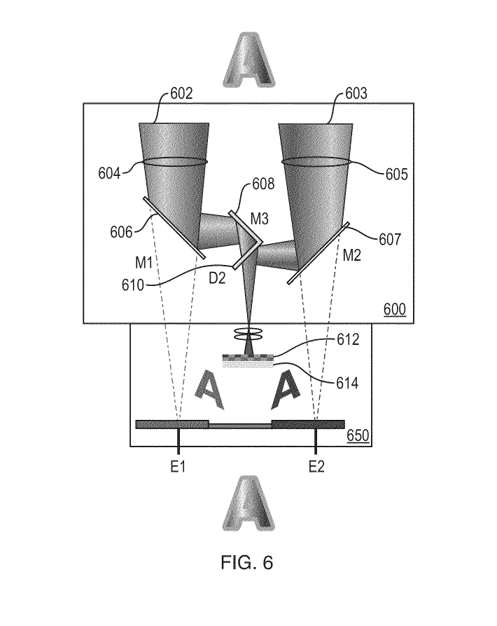

A further example embodiment of the present invention is the device 600 illustrated in FIG. 6. In contrast to the device 200 of FIG. 2, the device 600 does not include anaglyphic color filters disposed in its left-eye channel 602 and right-eye channel 603. Instead, the device 600 includes at least one color separation element configured to spatially separate color component rays of the left-eye beam 602 and of the right-eye beam 604.

As used herein, the term “color separation element” means “an optical filter capable of separating a “white light” into its component colors, such as a “rainbow” filter. As used herein, the phrase “color component ray” means a ray having a maximum intensity at one specific value of wavelength.

Referring to FIG. 6, the white-color left-eye beam 604 and white-color right-eye beam 605 is each reflected by broadband mirrors 606 and 607, respectively. The two reflected beams are then combined into a single combined beam by a beam combiner that includes a mirror M3 (608) and a rainbow filter D2 (610). The rainbow filter 610 has 50% transmission at a specified wavelength, for example 567 nm. Thus, a white-color beam can be split evenly into two parts. A beam reflected from the rainbow filter 610 has higher intensity of the color components having wavelengths below 567 nm, while a beam transmitted through rainbow filter 610 has higher intensity of the color components having wavelengths above 567 nm. Using this property of the rainbow filter 610, it is possible to separate the “red-rich” left-eye beam and the “blue-rich” right-eye beam spatially on the detector 614, thus encoding the depth of field information and capturing a stereoscopic image. This process is illustrated in FIG. 6.

FIG. 6 depicts a single-shutter image acquisition device 650 as being separate from the device 600. It is understood that in certain embodiments, the image acquisition device 650 may be an integral part of the device 600.

The device 600 can be used to capture color compensated 3D images without the use of a third, color-compensating channel as that of the device 500 of FIG. 5. A pair of anaglyph goggles would still be used to view the full color 3D image captured by the device 600. Alternatively, a post-image processing can be used to display the 3D image on a 3D display.

A person of ordinary skill in the art of image acquisition will appreciate that while the foregoing discussion referred to a Bayer mask as a means of color location at the CCD/CMOS sensor, other suitable technologies can also be employed with the devices described herein. One example of a Bayer mask alternative suitable for practicing with the present invention is a Foveon X3CMOC sensor. A Foveon X3 sensor uses an array of photosites, each of which consists of three vertically stacked photodiodes, organized in a two-dimensional grid. Each of the three stacked photodiodes responds to different wavelengths of light, thus capturing one of the three component colors.

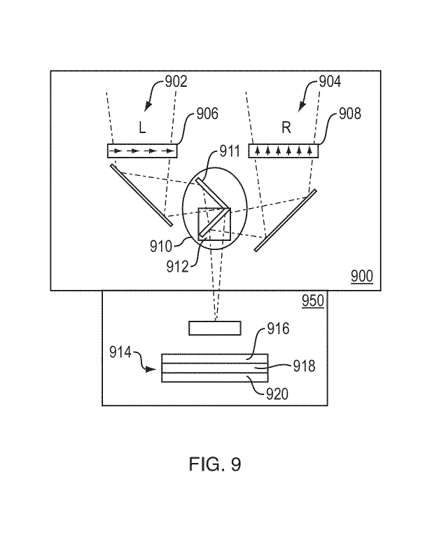

A further example embodiment of a device of the present invention is a device that relies on polarization, rather than color, to convey the depth-of-field information. In this embodiment, an image acquisition device to which the device of the invention attaches or of which the device of the invention is a part includes a polarization mosaic array mask such as the one described in U.S. Pat. No. 7,420,542, mentioned above. An example embodiment of such a device 900 is schematically depicted in FIG. 9. The device 900 includes a left-eye channel 902 including a first polarizing filter 906 configured to transform a left-eye beam into a first polarized beam having a first polarization. The device 900 further includes a right-eye channel 904 including a second polarizer element 908 configured to transform a right-eye beam into a second polarized beam having a second polarization. The first polarization is different from the second polarization. For example, the first polarization can be p-polarization, while the second polarization can be s-polarization. Other schemes are possible. The device 900 further includes a beam combiner 910 that includes a partially reflective mirror 911 and a polarizing beam-splitting cube 912. The beam combiner 910 combines the first and second polarized beams into a single combined beam.

FIG. 9 depicts a single-shutter image acquisition device 950 as being separate from the device 900. It is understood that in certain embodiments, the image acquisition device 950 may be an integral part of the device 900.

The device 950 includes a detecting module 914. The detecting module 914 includes Bayer mask (or a color array) 916, a polarization mosaic array 918, and a CCD/CMOC sensor 920.

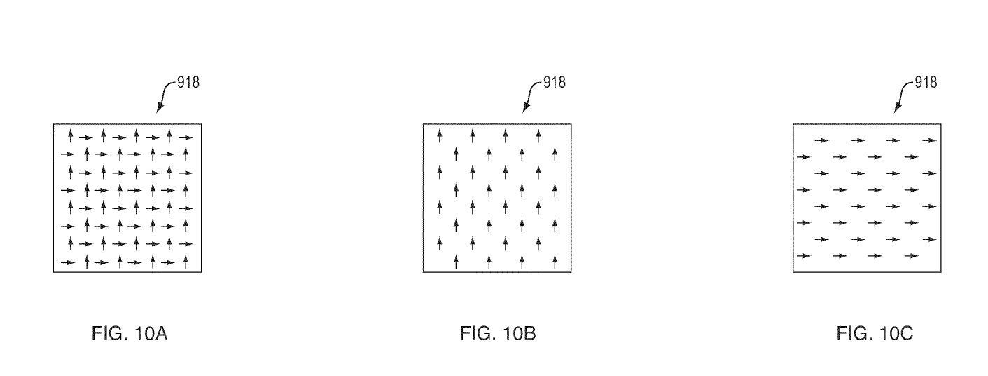

FIGS. 10A through 10C illustrate the principle of operation of the polarization mosaic array 918. The array comprises a plurality of cells transparent to the electromagnetic waves of interest (e.g., visible band), each cell being a switchable polarization filter. When the cells of the polarization mosaic array 918 assume the configuration shown in FIG. 10A, the pixels adjacent to each cell receive photons from either the left-eye beam (FIG. 10C) or the right-eye beam (FIG. 10B). As a result, both the left-eye image and the right-eye image will be detected by the detector 920, the photons from each beam being counted by its respective addressable wells.

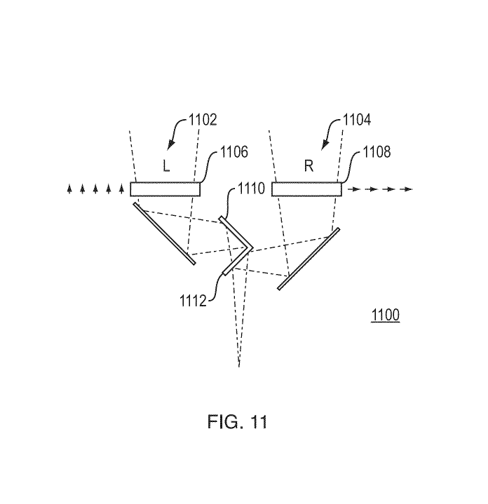

An alternative example embodiment of the device 900 is a device 1100, schematically shown in FIG. 11. As in the device 900, the device 1100 also includes a left-eye channel 1102 having a polarization filter 1106 and a right-eye channel 1104 having a polarization filter 1108. The polarization filters 1106 and 1108 impart different polarizations onto the left-eye beam and the right-eye beam. Unlike the device 900, the device 1100 employs a non-transparent mirror 1110, and a partially reflective mirror 1112 to combine the two beams into a single combined beam.

Although not shown in FIG. 11, a single-shutter image acquisition device may be an integral part of the device 1100.

As stated above, in one example embodiment, the present invention includes an image acquisition device having a frame rate. Using such an image acquisition device, each of the left-eye and right-eye images can be captured in its corresponding frame by the image acquisition device. In such an embodiment, the device employs a beam controller configured to alternatively transmit either the left-eye beam or the right-eye beam to the detector at a switching rate that is equal to or less than the frame rate of the detector. A beam controller can be implemented in a variety of ways known to a person of ordinary skill in the art.

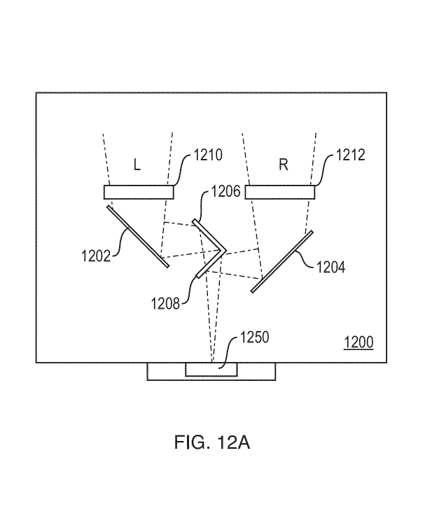

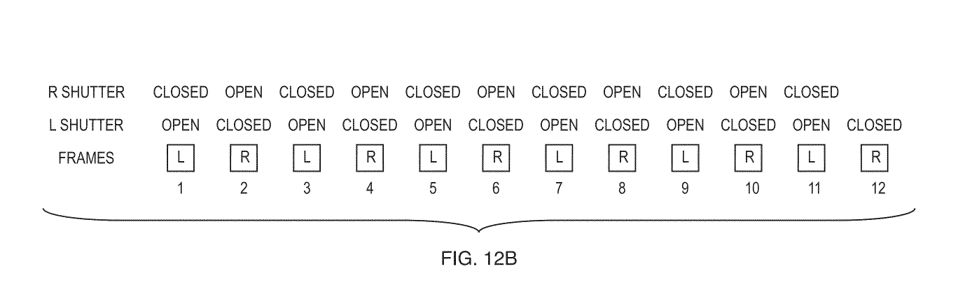

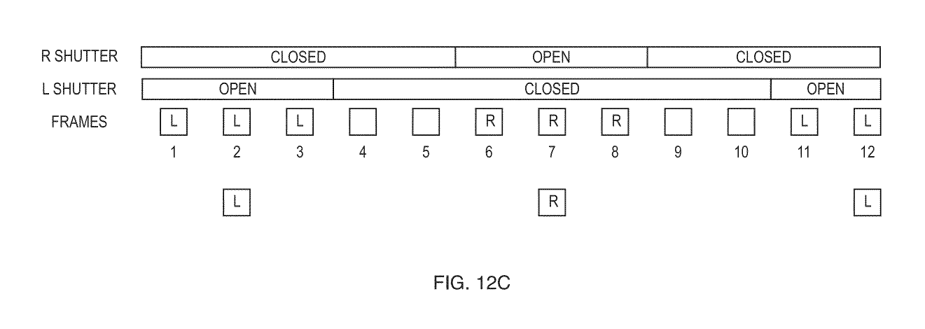

One example embodiment of such a device is illustrated in FIGS. 12A through 12C. Referring to FIG. 12A, a device 1200 includes a left-eye channel mirror 1202, a right-eye channel mirror 1204, a redirecting mirror 1206, a semitransparent (partially reflecting) mirror 1208, and an image acquisition device 1250 having a frame rate. The device 1200 further includes a left-eye shutter 1210 and a right-eye shutter 1212.

FIG. 12B is a schematic diagram of a synchronization scheme between the shutters 1210 and 1212 and the frames of the image acquisition device 1250. In this scheme, each consecutive frame (frames 1 through 12 are shown) is used to acquire either a left-eye (L) or a right-eye image (R). In this case, the switching rate of the shutters 1210 and 1212 is equal to the frame rate of the image acquisition device 1250.

FIG. 12C is a schematic diagram of an alternative synchronization scheme between the shutters 1210 and 1212 and the frames of the image acquisition device 1250 (frames 1 through 12 are shown). In this scheme, three consecutive frames are used to acquire either a left-eye (L) or a right-eye (R) image, with two consecutive frames separating the left-eye frames from the right-eye frames. In this case, the switching rate of the shutters 1210 and 1212 is less than the frame rate of the image acquisition device 1250.

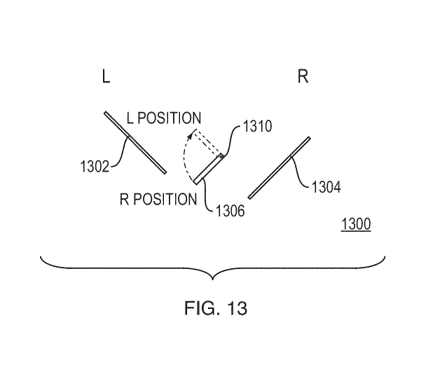

Another example embodiment of a device of the present invention is a device 1300 depicted in FIG. 13. The device 1300, similarly to the device 1200, includes a left-eye channel mirror 1302, a right-eye channel mirror 1304, as well as an image acquisition device having a frame rate (not shown in FIG. 13). Instead of the shutters, the device 1300 employs a movable double-sided mirror 1306. The movable mirror 1306 can rotate around a hinge 1310 and adopt either the right-eye position (R-position) or the left-eye position (L-position). In the corresponding positions, the movable mirror 1306 alternatively reflects either a left-eye beam or a right-eye beam toward the objective of an image acquisition device. The switching rate of the movable mirror 1306 between the R- and the L-positions is equal to or less than the frame rate of the image acquisition device, thus permitting the implementation of the synchronization schemes similar to those described above with references to FIGS. 12B and 12C.

The movable mirror 1306 can be actuated by any means known to a person of ordinary skill in the art, including a galvanometer or a solenoid. A proper alignment of the movable mirror 1306 with the optical axis of an objective lens of the image acquisition device can be ensured by mechanical stops that arrest the mirror's movement.

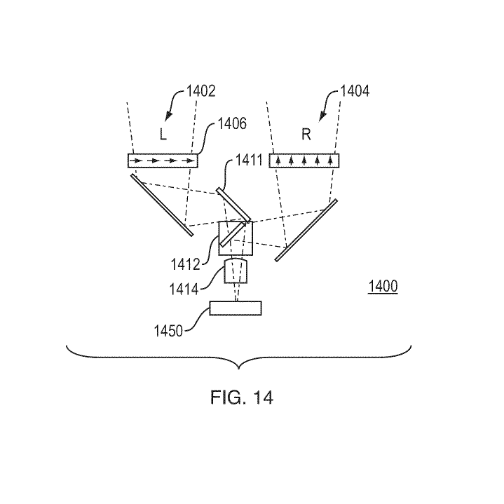

An example embodiment of the present invention is a device 1400 schematically depicted in FIG. 14. The device 1400 includes a left-eye channel 1402, including a first polarization filter 1406 configured to transform a left-eye beam into a first polarized beam having a first polarization. The device 1400 further includes a right-eye channel 1404, including a second polarization filter 1408 configured to transform a right-eye beam into a second polarized beam having a second polarization. The first polarization is different from the second polarization. For example, the first polarization can be p-polarization, while the second polarization can be s-polarization. Other schemes are possible. The device 1400 further includes a mirror 1411, a polarizing beam-splitting cube 1412, and an image acquisition device 1450 having a frame rate.

The device 1400 further includes a polarization selecting element 1414. The polarization selecting element 1414 can be any optical element known to transmit electromagnetic waves having a desirable polarization. Examples include liquid crystal-based polarizers, including spatial light modulators (SLMs), adjustable polarization filters, Pockels cells, or a mosaic polarization arrays described above with reference to FIGS. 9 and 10. The polarization selecting element 1414 is configured to alternatively transmit to the image acquisition device 1450 either the left-eye polarized beam or the right-eye polarized beam. The switching rate of the polarization selecting element 1414 between the two beams is equal to or less than the frame rate of the image acquisition device, thus permitting the implementation of the synchronization schemes similar to those described above with references to FIGS. 12B and 12C.

An image acquisition device 1450 can be a single-shutter device, and may be separate from the device 1400.

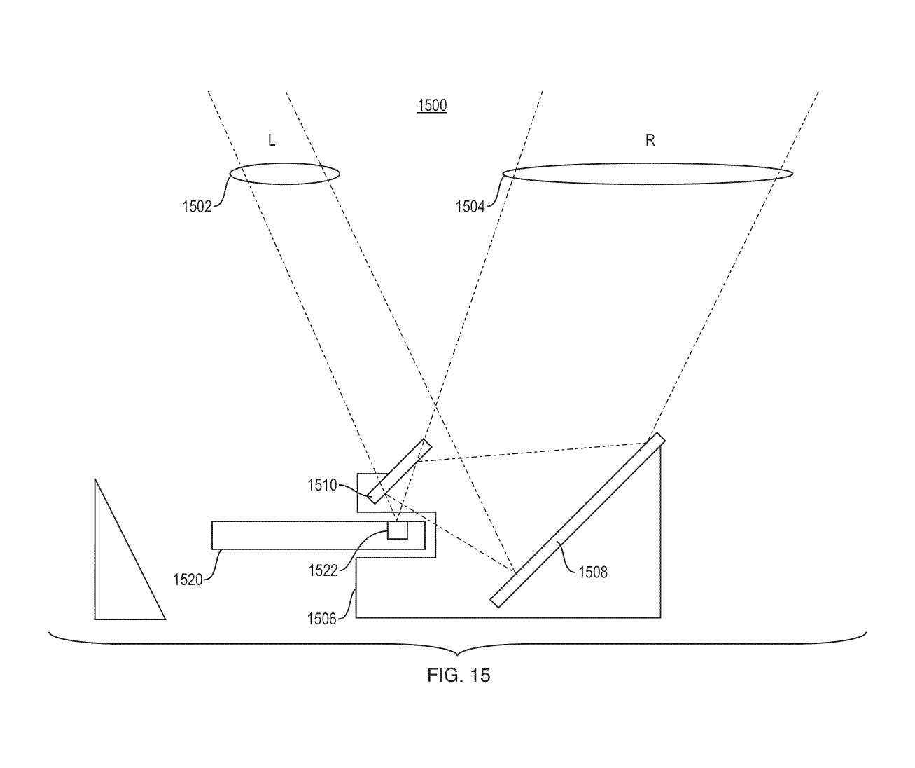

An example embodiment of the present invention is a device 1500 schematically depicted in FIG. 15. The device 1500 includes a body 1506. The body 1506 includes a mirror 1508 and a dichroic semitransparent mirror 1510. The dichroic semitransparent mirror 1510, for example, can transmit red and reflect blue colored portions of the visible spectrum. An image acquisition device 1520 (e.g. a smart phone) is disposed within the body 1506 so that an objective 1522 of the image acquisition device 1520 is exposed to both a beam reflected from the dichroic mirror 1510 and the beam that passed through the dichroic mirror 1510. In operation, a left eye beam 1502 impinges onto the dichroic mirror 1510, which transmits, for example, the red-colored component of the right-eye beam 1502 towards the objective 1522. The left-eye beam reflects off of the mirror 1508 and then also impinges onto the dichroic mirror 1510, which reflects, for example, the blue-colored component of the left-eye beam 1504 towards the objective 1522. As a result, the image acquisition device 1520 captured both color-encoded beams within a single frame.

In the embodiments of the present invention described above that employ capturing each of the left-eye and right-eye image in its corresponding frame of the image acquisition device (i.e. the embodiments that employ a beam controller configured to alternatively transmit either the left-eye beam or the right-eye beam to the detector at a switching rate that is equal to or less than the frame rate of the detector), the device of the present invention can further include a module configured to synchronize the beam controller and the detector. Synchronization can be accomplished, for example, by using a voltage sine wave or square wave to switch shutters on or off or to switch, or gate, the detected beam. This could be phase-locked with a trigger signal coming from an output of the camera so that the frames were perfectly synchronized with the shutter or beam transmitting elements. Alternatively the element controlling the shutters of the device described herein could produce a pulse that would tell the camera to take two or more pictures in rapid succession.

The stereoscopic images acquired using the embodiments of the present invention that rely on the color to encode the left-eye or the right-eye perspective can be viewed using a device for viewing the stereoscopic image is selected from goggles, a lenticular array, or a parallax array.

The stereoscopic images acquired using the embodiments of the present invention that rely on the polarization to encode the left-eye or the right-eye perspective can be viewed using the device for viewing the stereoscopic image (goggles, a lenticular array, or a parallax array) having polarization filters.

Additionally, the stereoscopic images can be viewed on a display configured to reproduce stereoscopic images. For example, left and right images can be displayed on a 3D TV screen where a passive system displays the left image at one polarization and the right image at an orthogonal polarization. The images can be displayed simultaneously or sequentially. In another example of a viewing device, left and right images are displayed, and goggles are actively synchronized to block the left and right eyes so that only the correct image is on when its corresponding eye is in the open goggle state. Another type of viewing device includes a display with a lenticular array attachment that enables a different set of pixels to be visible from the left or right eye perspectives. Similarly, a parallax system also will permit pixels to be visible by either the left or right eyes. Another example of a viewing device employs a side by side viewing system and a viewer that relaxes the eyes to see the stereo image. In any of the above embodiments, the present invention can include computer code instructions causing an image display apparatus to display the stereoscopic image.

It should be understood that a camera device or other electronic device, such as a handheld device, computer, or server, capturing or storing the stereographic images may be equipped with control logic, such as in the form of hardware, firmware, or software, configured to arrange the stereographic images for playback via a visual display. The stereographic images may be stored sequentially in left/right/left/right/ . . . order, in left and right image files, or in some other arrangement and encoded in some manner known in the art, such as having metadata associated with each image to indicate a sequence number and left or right channel indicator corresponding with corresponding parameters during image capture operations. The same or different control logic can be used to cause a display to produce graphical representations of the stereographic images to a viewer. The display may be a 2D display that coordinates with passive or active 3D viewing glasses, or the display may be a display that displays 3D images without the viewer's need to wear 3D viewing glasses. In the case of software, the electronic device includes a non-transitory computer-readable medium and a processor configured to read processor instructions stored thereon. The instructions may be a sequence of instructions in any suitable software language capable of performing operations disclosed herein. Similarly, the processor may be any form of processor that, after loading the instructions, can perform the operations or subset of operations disclosed herein. The non-transitory computer-readable medium may be any computer memory device, such as RAM, ROM, CD-ROM, or other memory storage device known in the art. Typical computer buses, input/output ports, hardware interfaces, processor logic, peripheral controllers, display controllers, and so forth may be included in the electronic device or display device or other device configured to operate in cooperation therewith.

Accordingly, in certain example embodiments, the present invention can be a kit. For example, in one example, the present invention is a kit comprising an attachment for acquiring a stereoscopic image, as described above, and a device for viewing the stereoscopic image. In another example, the present invention is a kit comprising an attachment for acquiring a stereoscopic image, as described above, and a computer-readable media with computer code instructions stored thereon, the computer code instructions causing an image display apparatus to display the stereoscopic image.

While this invention has been particularly shown and described with references to example embodiments thereof, it will be understood by those skilled in the art that various changes in form and details may be made therein without departing from the scope of the invention encompassed by the appended claims.

1. An attachment for acquiring a stereoscopic image, the attachment comprising:
a left-eye channel;
a right-eye channel; and
a beam combiner,
the left-eye channel configured to relay a left-eye beam to the beam combiner,
the right-eye channel configured to relay the right-eye beam to the beam combiner,
the beam combiner configured to combine the left-eye beam with the right-eye beam and to form a combined beam,
the attachment further including a color separation element configured to spatially separate color component rays of the left-eye beam and of the right-eye beam.

2. The attachment of claim 1, further including a means for securing the attachment on an image acquisition device.

3. The attachment of claim 2, wherein the image acquisition device is a single-shutter image acquisition device selected from a mobile phone, a photographic camera, or a video camera.

4. The attachment of claim 1, the left-eye channel and the right-eye channel each including a mirror.

5. The attachment of claim 1,
the beam combiner including a dichroic element,
the beam combiner combining the first and second anaglyphically colored beams into the single combined beam.

6. The attachment of claim 1,
the left-eye channel including a first anaglyphical color filter configured to transform the left-eye beam into the first anaglyphically colored beam; and
the right-eye channel including a second anaglyphical color filter configured to transform the right-eye beam into the second anaglyphically color beam.

7. (canceled)

8. The attachment of claim 1, further including a third color channel configured to relay a color correction beam to the beam combiner, the beam combiner combining the left-eye beam, the right-eye beam, and the color correction beam into the combined beam.

9. The attachment of claim 8, the third color channel including a color filter.

10. An attachment for acquiring a stereoscopic image, the attachment comprising:
a left-eye channel;
a right-eye channel; and
a beam combiner,
the left-eye channel configured to relay a left-eye beam to the beam combiner,
the right-eye channel configured to relay the right-eye beam to the beam combiner,
the beam combiner configured to combine the left-eye beam with the right-eye beam and to form a combined beam,
the left-eye channel including a first polarizing filter configured to transform the left-eye beam into a first polarized beam having a first polarization; and
the right-eye channel including a second polarizer element configured to transform the right-eye beam into a second polarized beam having a second polarization,
the first polarization being different from the second polarization.

11. The attachment of claim 10,
the beam combiner including a polarizing beam-splitting cube,
the beam combiner combining the first and second polarized beams into the combined beam.

12. The attachment of claim 10,
the beam combiner including a partially reflective mirror,
the beam combiner combining the first and second polarized beams into the combined beam.

13. A system for acquiring a stereoscopic image, the system comprising:
an attachment for acquiring a stereoscopic image, the attachment comprising:
a left-eye channel;
a right-eye channel; and
a beam combiner,
the left-eye channel configured to relay a left-eye beam to the beam combiner,
the right-eye channel configured to relay the right-eye beam to the beam combiner,
the beam combiner configured to combine the left-eye beam with the right eye beam and to form a combined beam; and
an image acquisition device,
the attachment further including a color separation element configured to spatially separate color component rays of the left-eye beam and of the right-eye beam

14. The system of claim 13, wherein the attachment includes a means for securing the attachment on the image acquisition device.

15. The system of claim 14, wherein the image acquisition device is a single shutter image acquisition device selected from a mobile phone, a photographic camera, or a video camera.

16. A kit, comprising:
an attachment for acquiring a stereoscopic image, the attachment comprising:
a left-eye channel;
a right-eye channel; and
a beam combiner,
the left-eye channel configured to relay a left-eye beam to the beam combiner,
the right-eye channel configured to relay the right-eye beam to the beam combiner,
the beam combiner configured to combine the left-eye beam with the right eye beam and to form a combined beam; and
a device for viewing the stereoscopic image,
the attachment further including a color separation element configured to spatially separate color component rays of the left-eye beam and of the right-eye beam

17. The kit of claim 16, wherein the device for viewing the stereoscopic image is selected from goggles, a lenticular array, or a parallax array.

18. The kit of claim 16, the device for viewing the stereoscopic image being configured for viewing a stereoscopic image acquired with a single shutter image acquisition device selected from a mobile phone, a photographic camera, or a video camera.

19. A kit, comprising:
an attachment for acquiring a stereoscopic image, the attachment comprising:
a left-eye channel;
a right-eye channel; and
a beam combiner,
the left-eye channel configured to relay a left-eye beam to the beam combiner,
the right-eye channel configured to relay the right-eye beam to the beam combiner,
the beam combiner configured to combine the left-eye beam with the right eye beam and to form a combined beam; and
a computer-readable medium with computer code instructions stored thereon, the computer code instructions causing an image display apparatus to display the stereoscopic image.

20. A system for acquiring a stereoscopic image, the system comprising:
a detector having a frame rate;
a left-eye channel;
a right-eye channel;
a beam controller,
the left-eye channel configured to relay a left-eye beam to the detector,
the right-eye channel configured to relay a right-eye beam to the detector,
the beam controller configured to alternatively transmit either the left-eye beam or the right-eye beam to the detector at a switching rate that is equal to or less than the frame rate of the detector.

21. The system of claim 20, the beam controller including a left-eye channel shutter, and a right-eye channel shutter, the shutters operable to alternatively block either the left-eye beam or the right-eye beam at the switching rate that is equal to or less than the frame rate of the detector.

22. The system of claim 20, the beam controller including a movable mirror operable to alternatively direct either the left-eye beam or the right-eye beam to the detector at a switching rate that is equal to or less than the frame rate of the detector.

23. The system of claim 20,
the left-eye channel including a first polarizing filter configured to transform the left-eye beam into the first polarized beam having a first polarization;
the right-eye channel including a second polarizer element configured to transform the right-eye beam into the second polarized beam having a second polarization, the first polarization being different from the second polarization; and
the beam controller including a polarization selection element operable to alternatively transmit either the left-eye beam or the right-eye beam to the detector at the switching rate that is equal to or less than the frame rate of the detector.

24. The system of claim 20, further including a module configured to synchronize the beam controller and the detector.

25. The system of claim 20, wherein the detector is a single shutter image acquisition device selected from a mobile phone, a photographic camera, or a video camera.

26. A method for acquiring a stereoscopic image, the method comprising:
transmitting a left-eye beam, carrying a left-eye image through a color separation element;
transmitting a right-eye beam, carrying a right-eye image through the color separation element, the color separation element configured to spatially separate color component rays of the left-eye beam and of the right-eye beam;
acquiring a left-eye image, carried by a left-eye beam;
acquiring a right-eye image, carried by a right-eye beam; and
combining the left-eye image and the right-eye image to form a combined image.

27. The method of claim 26, further including capturing the combined image.

28. The method of claim 26, wherein
acquiring the left-eye image includes passing the left-eye beam through a first anaglyphical color filter configured to transform the left-eye beam into the first anaglyphically colored beam; and
acquiring the right-eye image includes passing the right-eye beam through a second anaglyphical color filter configured to transform the right-eye beam into the second anaglyphically colored beam.

29. The method of claim 28, wherein combining the left-eye image and the right-eye image includes combining the first and second anaglyphically colored beams into the single combined beam.

30. The method of claim 26, further including
acquiring a color-correcting image, carried by a color-correcting beam; and
combining the left-eye image, the right-eye image, and the color-correcting image to form a color-corrected combined image.

31. A method for acquiring a stereoscopic image, the method comprising:
acquiring a left-eye image, carried by a left-eye beam;
acquiring a right-eye image, carried by a right-eye beam; and
combining the left-eye image and the right-eye image to form a combined image, wherein
acquiring the left-eye image includes passing the left-eye beam through a first polarizing filter configured to transform the left-eye beam into a first polarized beam having a first polarization; and
acquiring the right-eye image includes passing the right-eye beam through a second polarizing filter configured to transform the right-eye beam into a second polarized beam having a second polarization,
the first polarization being different from the second polarization.

32. The method of claim 31, wherein combining the left-eye image and the right-eye image to form a combined image includes combining the first and second polarized beams into the combined beam.

33. A method for acquiring a stereoscopic image, the method comprising:
acquiring a left-eye image carried by a left-eye beam;
acquiring a right-eye image, carried by a right-eye beam; and
alternatively transmitting either the left-eye beam or the right-eye beam to a detector at a switching rate, the detector having a frame rate, the switching rate being equal to or less than the frame rate of the detector.

34. The method of claim 33, further including synchronizing the alternative transmission and frame acquisition by the detector.

35. An apparatus for acquiring a stereoscopic image, the apparatus comprising:
means for separating color component rays of a left-eye beam and of a right-eye beam;
means for acquiring the left-eye image, carried by the left-eye beam;
means for acquiring the right-eye image, carried by the right-eye beam; and
means for combining the left-eye image and the right-eye image into a combined image.

36. The apparatus of claim 35, further including means for capturing the combined image.

37. An apparatus for acquiring a stereoscopic image, the apparatus comprising:
means for acquiring a left-eye image carried by a left-eye beam;
means for acquiring a right-eye image, carried by a right-eye beam; and
means for alternatively transmitting either the left-eye beam or the right-eye beam to a detector at a switching rate, the detector having a frame rate, the switching rate being equal to or less than the frame rate of the detector.

38. The apparatus of claim 37, further including means for synchronizing the alternative transmission and frame acquisition by the detector.

39. A system for acquiring a stereoscopic image, the system comprising:
an attachment for acquiring a stereoscopic image, the attachment comprising:
a left-eye channel;
a right-eye channel; and
a beam combiner,
the left-eye channel configured to relay a left-eye beam to the beam combiner,
the right-eye channel configured to relay the right-eye beam to the beam combiner,
the beam combiner configured to combine the left-eye beam with the right eye beam and to form a combined beam; and
an image acquisition device,
the left-eye channel including a first polarizing filter configured to transform the left-eye beam into a first polarized beam having a first polarization; and
the right-eye channel including a second polarizer element configured to transform the right-eye beam into a second polarized beam having a second polarization,
the first polarization being different from the second polarization.

40. The system of claim 39, wherein the attachment includes a means for securing the attachment on the image acquisition device.

41. The system of claim 40, wherein the image acquisition device is a single shutter image acquisition device selected from a mobile phone, a photographic camera, or a video camera.

42. A kit, comprising:
an attachment for acquiring a stereoscopic image, the attachment comprising:
a left-eye channel;
a right-eye channel; and
a beam combiner,
the left-eye channel configured to relay a left-eye beam to the beam combiner,
the right-eye channel configured to relay the right-eye beam to the beam combiner,
the beam combiner configured to combine the left-eye beam with the right eye beam and to form a combined beam; and
a device for viewing the stereoscopic image,
the left-eye channel including a first polarizing filter configured to transform the left-eye beam into a first polarized beam having a first polarization; and
the right-eye channel including a second polarizer element configured to transform the right-eye beam into a second polarized beam having a second polarization,
the first polarization being different from the second polarization.

43. The kit of claim 42, wherein the device for viewing the stereoscopic image is selected from goggles, a lenticular array, or a parallax array.

44. The kit of claim 42, the device for viewing the stereoscopic image being configured for viewing a stereoscopic image acquired with a single shutter image acquisition device selected from a mobile phone, a photographic camera, or a video camera.

45. An apparatus for acquiring a stereoscopic image, the apparatus comprising:
means for transforming a left-eye beam into a first polarized beam having a first polarization;
means for transforming a right-eye beam into a second polarized beam having a second polarization, the first polarization being different from the second polarization;
means for acquiring a left-eye image, carried by the first polarized beam;
means for acquiring a the right-eye image, carried by the second polarized beam; and
means for combining the left-eye image and the right-eye image into a combined image.

46. The apparatus of claim 45, further including means for capturing the combined image.
